(19) United States
(12) Patent Application Publication
(10) Pub. No.: US 2009/0015094 A1
(43) Pub. Date: Jan. 15, 2009

(54) ELECTRICAL ROTARY MACHINE AND METHOD OF MANUFACTURING THE SAME

(75) Inventor: Yuichiro YOSHITAKE, Abiko (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd

(21) Appl. No.: 12/171,315

(22) Filed: Jul. 11, 2008

(30) Foreign Application Priority Data
Jul. 11, 2007 (JP) 2007-182001

(51) Int. Cl. H02K 1/16; H02K 15/12

(52) U.S. Cl. 310/257; 29/596

(57) ABSTRACT

An electrical rotary machine includes coils including element wires wound, and a core holding the coil, wherein spaces, both between the coils and the core, and between the adjacent element wires, are filled with a heat-conductive insulating resin. A method of manufacturing the electrical rotary machine includes a first step of impregnating the coils and filling the space between the adjacent element wires with the heat-conductive insulating resin, and a second step of impregnating the coils and the core and filling the space between the coils and the core with the heat-conductive insulating resin.

### CROSS-REFERENCE TO RELATED APPLICATION(S)

This application claims the foreign priority benefit under Title 35, United States Code, § 119 (V1)-(d), of Japanese Patent Application No. 2007-182001A, filed on Jul. 11, 2007 in the Japan Patent Office, the disclosure of which is herein incorporated by reference in its entirety.

### BACKGROUND OF THE INVENTION

1. Field of the Invention

The present invention relates to an electrical rotary machine in which an element wire is wound on a core, and a method of manufacturing the electrical rotary machine.

2. Description of the Related Art

Electrical rotary machines such as an electric motor and an electric generator are demanded to achieve a high output, enable a reduction in size, and obtain an insulating property so as to operate on a high voltage. Electrical rotary machines as described below are conventionally used. For example, JP58-064015A discloses an insulating method of repeating steps a plurality of number of times. The steps includes forming an insulating layer by winding an insulating tape or an insulating sheet on a coil conductor, impregnating the coil conductor with a thermosetting resin in vacuum pressure, and heating and hardening the thermosetting resin coating the coil conductor after being taken out from a liquid of the thermosetting resin.

JP2005-269721A discloses an electrical rotary machine molded with a type of resin or two different types of resins, wherein a plurality of stator cores, in which a coil is wound, are disposed in a circumferential direction of a stator of the electrical rotary machine. JP2008-029142A discloses a claw-teeth electrical rotary machine in which an annular claw core and an annular coil are integrally molded with a filler of non-magnetic substance. However, JP2008-029142A does not disclose any concrete structure of the annular coil.

When a current flows through a coil wound in the electrical rotary machine, the coil generates heat. The heat is transmitted to the stator core via an enamel covering, a molding resin, and a slot insulator, and radiated by heat transfer on the surface of the stator core. To secure the insulating property, the slot insulator such as the insulating sheet or a bobbin fills a space between the coil and the stator core, which the electrical rotary machine includes. The insulating sheet (slot insulator, insulating film, liner) is made of polyamide paper. A heat transfer efficiency of the insulating sheet is low, about 0.1 W/mK, which prevents the electrical rotary machine form radiating the heat. Contact resistance generated between the slot insulator and the resin (coil, or stator core) also causes a temperature of the coil to be increased.

JP58-064015A discloses the insulating tape or the insulating sheet, which is likely to block the resin to be filled in the impregnation and cause a defective impregnation. Accordingly, the current flowing through the coil is limited so as to prevent the coil from heating up, which makes it difficult for the electrical rotary machine to achieve high output and reduce the size. A work of winding the insulating sheet on the coil extends a lead-time of the electrical rotary machine.

### BRIEF SUMMARY OF THE INVENTION

An aspect of the present invention provides an electrical rotary machine which can reduce a heat resistance, and a method of manufacturing the electrical rotary machine.

An electrical rotary machine of the present invention includes coils having element wires wound, a core for holding the coils and a heat-conductive insulating resin for filling spaces both between the coils and the core, and between the adjacent element wires. A method of manufacturing an electrical rotary machine, including coils having element wires wound, and a core for holding coils, comprises the steps of impregnating the coils and filling spaces between the adjacent element wires with a highly heat-conductive resin, and impregnating the coils and the core and filling spaces between the coils and the core with either the highly heat-conductive resin or other highly heat-conductive resin.

Spaces, both between the coils and the core, and between the adjacent element wires, are filled with the heat-conductive insulating resin, which reduces heat resistance between the element wires and the core. Consequently, the temperature of the element wires is decreased. The electrical rotary machine of the present invention can obtain a necessary insulating property by filling the spaces between the coils and the core with the heat-conductive insulating resin.

The electrical rotary machine of the present invention can reduce the heat resistance value.

### BRIEF DESCRIPTION OF THE DRAWINGS

FIG. 1 is an exploded perspective view showing a claw-pole electrical rotary motor of a first embodiment.

FIG. 2 is an exploded perspective view of a stator shown in FIG. 1.

FIG. 3A is a part of a cross sectional view of a prior art stator, and FIG. 3B is a part of a cross sectional view of the stator according to the first embodiment of the present invention.

FIG. 4 is a flowchart showing a process of impregnating the stator with a resin.

FIG. 5 is an exploded perspective view of a coil-holding die according to the first embodiment of the present invention.

FIG. 6 is a cross sectional view of the coil filled with a highly heat-conductive resin of the first embodiment of the present invention.

FIG. 7 is a cross sectional view of a mold of the first embodiment of the present invention.

FIG. 8 is a graph showing a relation between power density and heat conductivity of a resin.

FIG. 9 is a cross sectional view of an open-slot electrical rotary machine according to a second embodiment of the present invention.

FIG. 10A is a cross sectional view of a comparative example of a prior art stator. FIG. 10B is a cross sectional view of a stator of the electrical rotary machine according to the second embodiment of the present invention.

### DETAILED DESCRIPTION OF THE PREFERRED EMBODIMENTS

### First Embodiment

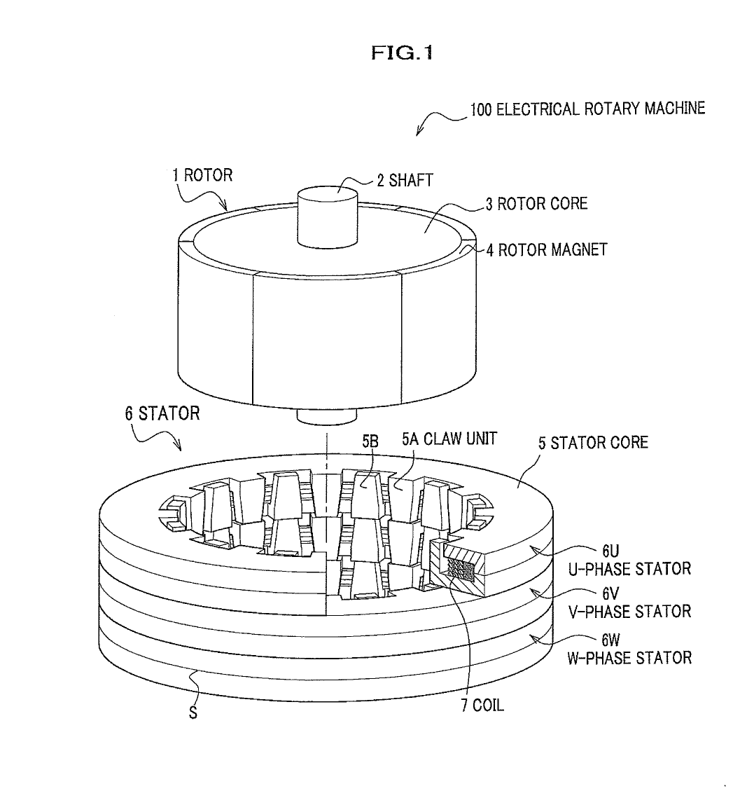

FIG. 1 shows a three-phase claw-pole electrical rotary machine of a first embodiment of the present invention. The three-phase claw-pole electrical rotary machine includes a stator core of three-dimensional claw-pole structure which allows a reduction in size, achieves a high motor torque, and improves an efficiency of outputting.

In FIG. 1, an electrical rotary machine 100 includes a rotor 1 and a stator 6 of which three phases (6U, 6V, and 6W) are connected in an axial direction. The rotor 1 includes a shaft 2, a rotor core 3, in which the shaft 2 is inserted, and the even number of rotor magnets 4 disposed on an outer circumferential face of the rotor core 3. The stator 6 includes stator cores 5 (core of the electrical rotary machine) and coils 7. Elements marked with the same number in FIG. 1 are common in other figures.

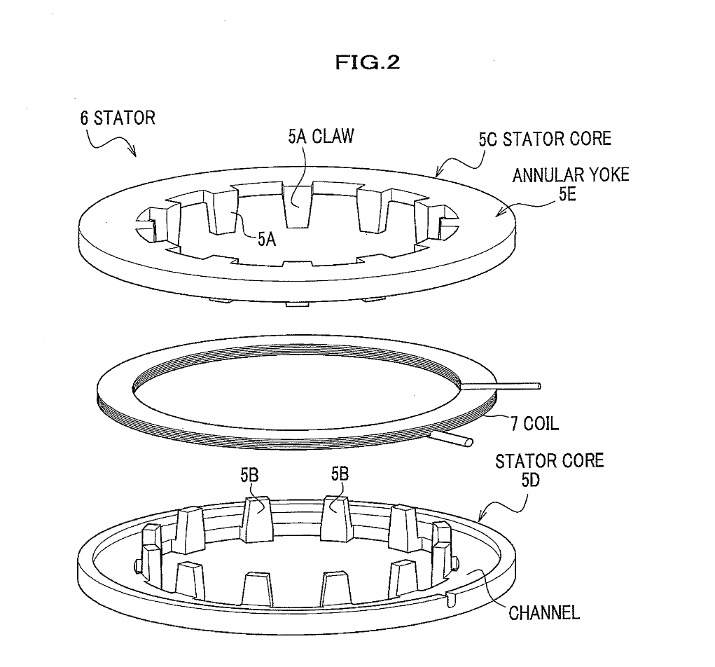

FIG. 2 shows a perspective view of a structure of the stator 6. The stator 6 for one of three phases includes two stator cores 5C and 5D which engage with each other, an annular coil 7 held in a channel formed between the stator cores 5C and 5D on the outer circumferential side of claws 5A and 5B. The annular coil 7 held in the channel is molded with a resin. The stator cores 5 and 5′ are formed by compression and molding of magnetic powder in the axial direction of the stator, and comprise an annular yoke 5E including an edge having an L-shape of cross-section, and a plurality of claws 5A and 5B alternately protruding from both sides of inner circumferential surfaces of the annular yoke 5E at a regular interval and extending in the axial direction of the stator. The claws 5A and 5B can be engaged with each other. FIG. 1 shows a boundary line S between the stator cores 5C and 5D, which are engaged with each other. The channel formed by engaging the stator core 5C with the stator core 5D is formed on the inner circumferential face of the stator 6.

When a current flows through the coil 7 of the stator 6, magnetic paths are formed between the annular yoke 5E of the stator core 5 and the claw 5A, between the annular yoke 5E and a space formed between the claws 5A and 5B in the circumferential direction, and between the annular yoke 5E and the claw 5B. The claws 5A and 5B are magnetized into different polarities. When three-phase alternating currents are applied to the coils 7 of stators (6U, 6V, and 6W), an intensity of magnetic forces and polarities of the claws 5A and 5B are shifted along with three phases, which forms a rotating magnetic field in the stator 6. Depending on the position between the rotating magnetic field and rotor 1 (FIG. 1), an attracting force or a repulsive force acts on a rotor magnet 4, and the rotor 1 rotates.

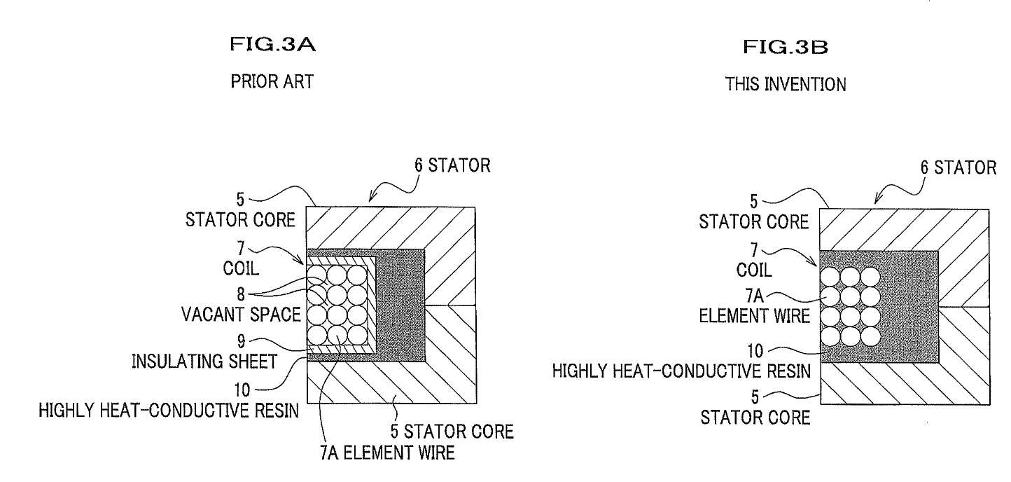

FIG. 3A shows a comparative example of a stator having an insulating sheet. As shown in FIG. 3A, a coil 7 is tightly wound with the insulating sheet 9 (insulating tape) of which right half overlaps the left half in the width direction of the sheet 9. The stator 6 includes the coil 7 covered with the insulating sheet 9. The coil 7 is disposed in the channels (FIG. 2) between the stator cores 5C and 5D and molded with a highly heat-conductive resin 10 (for example, unsaturated polyester resin). The insulating sheet 9 is tightly wound not to leave a gap between the coil 7 and the insulating sheet 9. Accordingly, the coil 7 does not make contact with the highly heat-conductive resin 10. The gaps are formed between the element wires 7A of the coil 7. On the other hand, as shown with the embodiment of the present invention in FIG. 3B, the insulating sheet 9 is not used, and the highly heat-conductive resin 10 fills the space between the adjacent element wires 7A, and a space between a surface of the element wire 7A of the coil 7 and the stator core 5, which forms a continuous thermal conductive channel. The heat conductivity of the highly heat-conductive resin 10 is increased by kneading non-magnetic substance powder, as a filler, of any of alumina, zirconia, and silica, or a combination of these substances.

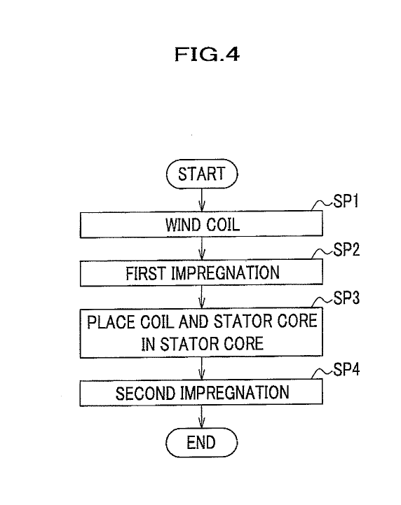

A method of manufacturing the coil 7 of the electrical rotary machine 100 (FIG. 1) of the embodiment will be described with reference to FIG. 4.

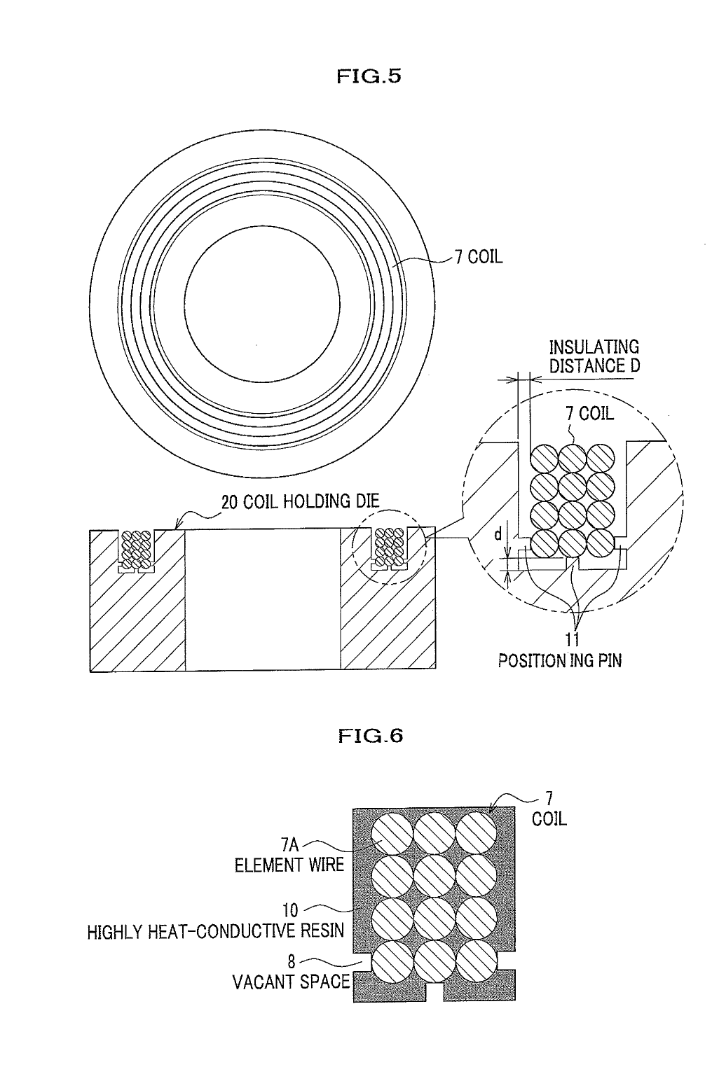

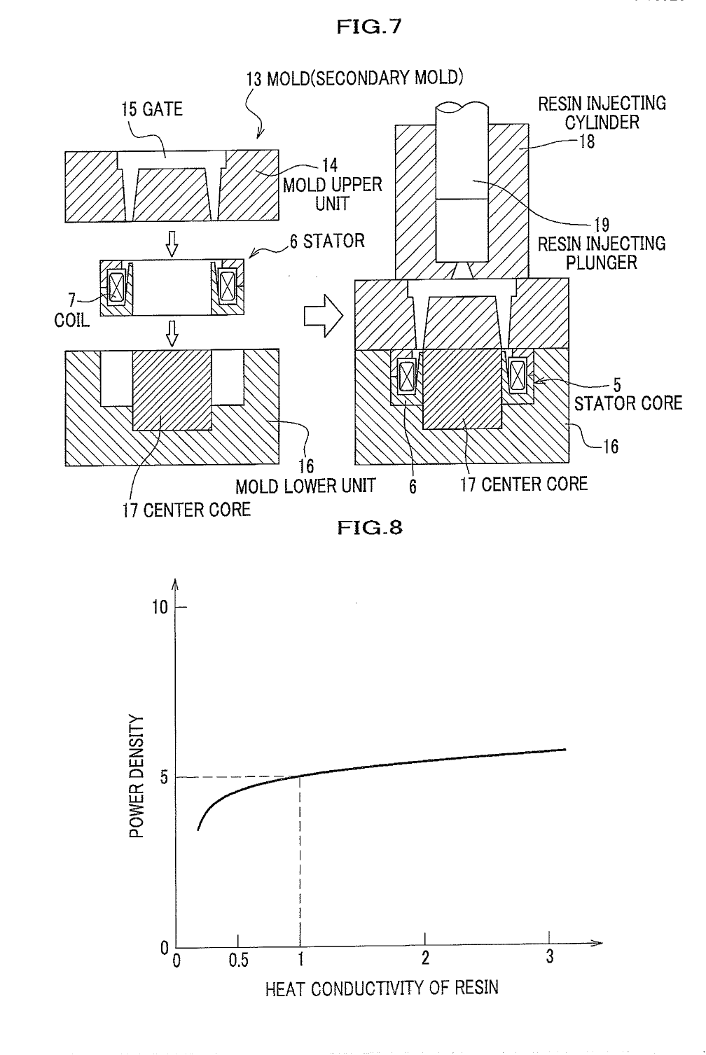

FIG. 4 shows a flowchart of the method of manufacturing the coil 7. In a step SP1, a coil winding machine winds a linear element wire 7A (FIG. 3B) on a bobbin to form the coil 7. On shaping the coil to prevent deformation of the coil, a self-welding wire can be used through heating by conducting process. Either a round wire or a rectangular copper wire can be used for the element wire of the coil 7, and the shape of the element wire is not specified. The diameter of the element wire of the coil 7 ranges from 0.3 to 0.8 mm. In a step SP2, to secure an insulating distance from the outer diameter of the coil 7, the coil 7 is disposed in a coil-holding die 20 (FIG. 5), and treated by a first impregnation (for example, vacuum pressurizing impregnation) using the highly heat-conductive resin 10. In a step SP3, the coil 7 and the stator core 5 are disposed in a mold 13 (FIG. 7). In a step SP4, a second impregnation using the highly heat-conductive resin 10 (or other highly heat-conductive resin) is carried out. Hereinafter, the first and second impregnation treatments will be described in detail.

FIG. 5 shows a cross-sectional view and an enlarged view of the coil-holding die 20. When the coil 7 is impregnated in a liquid of the highly heat-conductive resin so as to adequately form an insulating layer of the highly heat-conductive resin 10, the element wires 7A of the coil 7 need to be fixed with positioning pins 11 so as to secure the insulating distance D. The insulating layer may as well be formed by using a die having convex and concave parts equivalent to the positioning pins 11.

Preferably, the coil-holding die 20 is designed in consideration of manufacturing error of the coil 7.

In the electrical rotary machine of the molding method as shown in FIG. 3A, the insulating sheet 9 and the stator core 5 are separately impregnated, which causes a block in the impregnation, and the spaces between the element wires of the coil 7 are not fully impregnated with the resin. Accordingly, separation and void is likely to be generated in the conventional electrical rotary machine, of which heat radiating property and insulating property is decreased.

On the other hand, the electrical rotary machine of the present invention as shown in FIG. 3B is impregnated in two-stage process, and can reduce the generation of the void, wherein the coil 7 is impregnated with the resin in the first impregnation, and the spaces between the element wires of the coil 7 are impregnated with the highly heat-conductive resin 10 in the second impregnation, without depending on the structure of the stator core 5. A lead time of the electrical rotary machine can be reduced because the process of winding the insulating sheet is omitted, which makes it easier to mass-produce the electrical rotary machine.

However, preferably, the insulating sheet 9 is partially wound so as to secure an adequate insulating distance in a leading unit of the electrical rotary machine 100, where a high insulating property is required because an electrical field intensity is high. An insulating tape such as a glass cloth tape can be used instead of the insulating sheet 9.

FIG. 6 shows the coil 7 in which the insulating layer of the highly heat-conductive resin 10 forms in the spaces between the adjacent element wires 7A, and on the outer circumferential faces of the element wires 7A. As shown in FIG. 6, the vacant spaces 8 formed by the positioning pins are left. Apart from the vacant spaces, it is required to visually confirm whether or not the coil 7 protrudes from the insulating layer. A burr of the highly heat-conductive resin 10 should be removed.

The coil 7 impregnated with the highly heat-conductive resin 10 in the first impregnation is disposed in the stator core 5. FIG. 7 shows a cross sectional view of the mold 13 (referred to as a secondary mold designed to be molded for the whole of the electrical rotary machine). The mold 13, molded by injection molding or transfer molding, includes an upper mold 14 providing a gate 15 where the resin is injected, a lower mold 16 providing a cylindrical center core 17 in the axial direction, a resin injecting cylinder 18, and a resin injecting plunger 19.

The stator 6 is disposed in the mold 13 (secondary mold). The highly heat-conductive resin 10 (molding resin) having thermoplastic and thermosetting properties is filled into the resin injecting cylinder 18, and pressed by the resin injecting plunger 19. The spaces, both between the stator core 5 and the coil 7 and between the stator 5′ and the coil 7, are filled with the molding resin through the gate 15. Accordingly, an insulating property is held. When the vacant spaces 8 (FIG. 6) formed by the positioning pins 11 are directed to the gate 15 of the mold 13, the vacant spaces 8 can easily be filled with the molding resin.

JP58-64015A and JP2005-169721A disclose a coating technology of covering the coil 7 with an insulator such as the insulating sheet 9 (FIG. 3), wherein the contact thermal resistance generates on the top and back surfaces of the insulating sheet 9. However, the embodiment of the present invention having no insulating sheet can reduce a temperature increase because the contact thermal resistance generates only on the top surface of the first insulating layer.

FIG. 8 is a graph showing a relation between a resin thermal conductivity and a power density. The resin thermal conductivity is required to become equal to or more than 1 W/mK so as to keep the power density of 5 W/cm³ of the electrical rotary machine 100. In the embodiment, the thermal conductivity of the resin using for the first and second impregnations is about 5 W/mK. Accordingly, the electrical rotary machine 100 can achieve a reducing ratio of 23 percent, regarding the temperature increase. A different resin can be used for the first and second impregnations. For example, in the first impregnation, a resin having a good fluidity can be used so as to fill in the spaces between element wires without difficulty, and in the second impregnation, a resin having a high heat conductivity can be used for carrying heat. Consequently, the electrical rotary machine including the stator 6 can improve the power density by 10 percent, compared with the conventional electrical rotary machine as shown in FIG. 3A.

The electrical rotary machine 100 of the embodiment can fill the spaces, both between the adjacent element wires 7A, and between the coils 7 and the stator core 5, with the highly heat-conductive resin 10, and generate a continuous heat transfer path of the highly heat-conductive resin 10 from the element wires 7A to stator core 5. Accordingly, the temperature of the electrical rotary machine is decreased. The spaces between the coils 7 and the stator core 5 are filled with the highly heat-conductive resin 10 having a high insulating property, which gives the electrical rotary machine 100 a necessary insulating property and allows the machine 100 to operate on a high voltage.

### Second Embodiment

The claw-pole electrical rotary machine using the coil 7 is described in the first embodiment. An open-slot synchronous machine using a distributed winding coil will be described in a second embodiment.

The synchronous machine (electrical rotary machine) is driven by an inverter which converts a direct electric power supplied by a battery into an alternate electric power, which is favorable so as to achieve a high output and control a weak magnetic field. It is important for the synchronous machine to obtain a high heat conductivity in order to achieve a high output.

FIG. 9 shows a cross-sectional view on a plane along the axial direction of rotation of an electrical rotary machine 110 of the second embodiment. As shown in FIG. 9, the electrical rotary machine 110 of the second embodiment includes a stator 21, and a rotor 1 disposed via a vacant space on an inner circumferential side of the stator 21 and held rotatable. The stator 21 and the rotor 1 are held in a housing 22 of the electrical rotary machine 110.

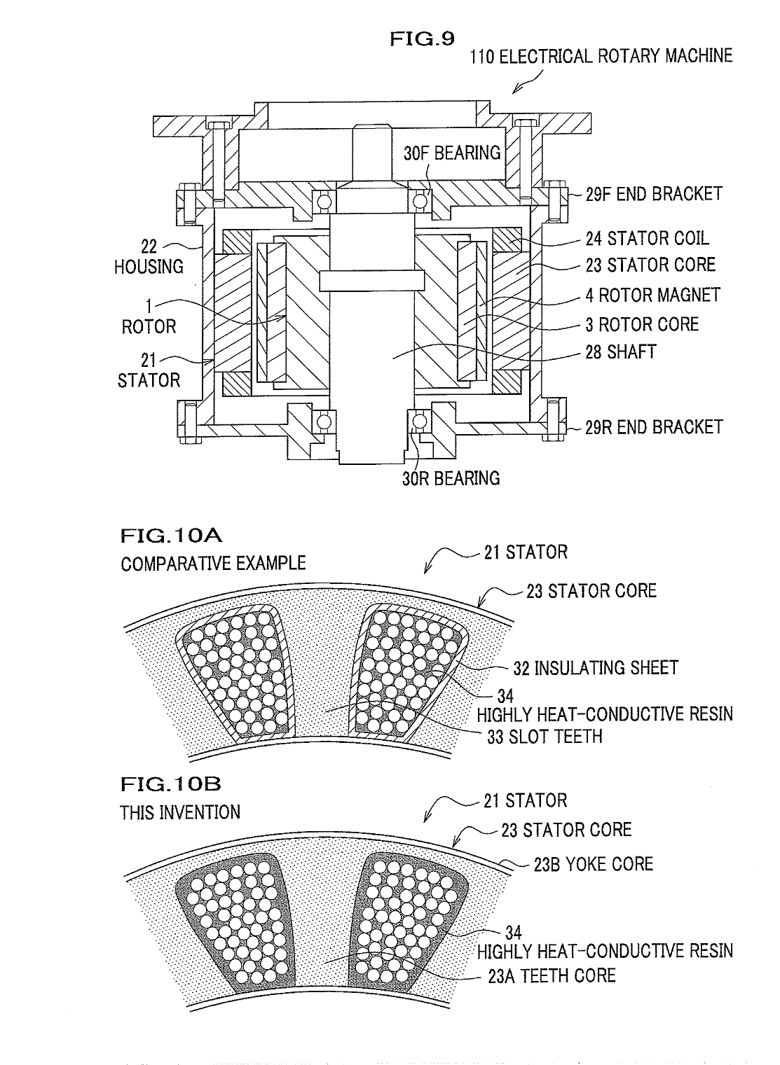

The stator 21 includes a stator core 23 and a stator coil 24. The stator core 23 is formed by laminating thin steel plates of a predetermined shape formed by press molding. A plurality of continuous slots are formed in the axial direction in an inner circumstantial unit of the stator 23, of which the inner circumferential face side is open. These slots are groove-shaped space units formed between teeth cores 23A (FIG. 10) adjoining in the circumferential direction. In the embodiment, 48 pieces of slots are formed. The stator coil 24 is wound on the teeth cores 23A of the stator core 23 by distributed winding. The distributed winding is a method of winding the stator coil 24 on the stator core 23 wherein the coil wound on the tooth core through two slots is distributed to the plurality of slots.

An insulating sheet 25 not shown is folded and inserted into the slots before the stator coil 24 is wound on the stator core 23. The glass cloth tape is used in the embodiment instead of the insulating sheet 25.

The stator coil 24 includes a U-phase stator coil, a V-phase stator coil, and a W-phase stator coil, which are continuously wound by laminating a coil conductor. The stator coil 24 is wound by an automatic coil winding machine on a spool not shown through a predetermined procedure and is inserted into the slots of the opening unit of the stator core 23 by an automatic coil inserting machine not shown. The stator coil 24 is inserted into the slots in the order of the U-phase stator coil, the V-phase stator coil, and the W-phase stator coil. Coil end units of the stator coil 24 protrude from the slots in both axial directions and are disposed on both end faces of the axial direction of the stator core 23.

The rotor 1 includes a rotor core 3, a rotor magnet 4, and a shaft 28. The rotor core 3 is formed by laminating thin steel plates of a predetermined shape formed by press molding and fixed to the shaft 28. Magnet inserting holes being penetrated in the axial direction of the rotor 1 are formed at a regular interval in the circumferential direction in the outer circumferential unit of the rotor core 3. The rotor magnet 4 is inserted into each magnet inserting hole and fixed. The shaft 28 is rotatably supported by end brackets 29F and 29R fixed on both sides of a housing 22, and bearings 30F and 30R.

A method of impregnating the coils and the core at two stages without using the insulating sheet will be described hereinafter. FIG. 10 shows a cross sectional view of a radial direction of the stator 21. An insulating sheet 32 is disposed between the coil 7 and stator core 23 as shown with the structure of a comparative example in FIG. 10A. The stator of the present invention does not include the insulating sheet 32, and forms a continuous path of a highly heat-conductive resin 34 from the coil 7 to the stator core 23. The stator core 23 includes an annular yoke core 23B and a plurality of teeth cores 23A protruding in the radial direction and being disposed at a regular interval in the circumferential direction. The teeth core 23A and the yoke core 23B are integrally formed. The effect of impregnating the coil without the insulating sheet in the second embodiment is same as that of the first embodiment. A method of manufacturing the electrical rotary machine of the present invention will be described hereinafter.

In the open-slot motor such as the electrical rotary machine 110, the coil 7 is wound after the folded insulating sheet is inserted into the slot teeth 33. Insulating property is secured as follows.

As shown with the first embodiment, the insulating layer is formed in the stator core, not on the outer circumferential face of the coil 7. To be specific, the stator core 23 is disposed in a first impregnating mold and impregnated with a resin so as to secure an insulating distance from the outer diameter of the slot teeth. Subsequently, the whole of the stator is molded into a second mold in the same manner as the first embodiment. The electrical rotary machine of the embodiments can reduce a thermal resistance, a contact thermal resistance, and a defective impregnation, which JP58-064015A discloses.

The electrical rotary machine of the present invention can form the continuous path of the highly heat-conductive resin between the coils and stator core and improve the power density.

### Modified Embodiment

The present invention is not limited to the embodiments, but may be modified as described below.

In the embodiments, the spaces between the stator core 5 and the coils 7 of the stator are impregnated with the resin. A rotator (rotor), in which the coils 7 are wound, can be impregnated with the resin. The rotator core described in claims of the present invention includes the stator core and the rotor core.

In the second embodiment, the synchronous machine is used, but an induction machine can be applied as well.

What is claimed is:

1. An electrical rotary machine comprising:
coils including element wires wound;
a core for holding the coils; and
a heat-conductive insulating resin for filling spaces both between the coils and the core, and between the adjacent element wires.

2. The electrical rotary machine according to claim 1, further comprising a heat transfer path comprising the heat-conductive insulating resin for carrying heat, the path forming from the element wire to the core.

3. The electrical rotary machine according to claim 1, wherein the core is an annular stator core comprising a channel formed on an inner circumferential face and a plurality of claws alternately extending in both axial directions from the inner circumferential face.

4. The electrical rotary machine according to claim 1, wherein the core is a stator core comprising a plurality of slot teeth protruding at a regular angle on an inner circumferential face, and wherein the coil is wound by using a slot formed between the slot teeth.

5. The electrical rotary machine according to claim 1, further comprising a rotator, which is rotatable on an axis of the stator core, and included in an inner circumferential unit of the stator core.

6. The electrical rotary machine according to claim 1, wherein a heat transfer efficiency of the heat-conductive insulating resin is equal to or higher than 1 W/mK.

7. The electrical rotary machine according to claim 1, wherein non-magnetic substance powder of any of alumina, zirconia, and silica, and a combination of these substances, is kneaded for the heat-conductive insulating resin.

8. A method of manufacturing an electrical rotary machine including coils having element wires wound and a core for holding the coils, the method comprising the steps of.
impregnating the coils and filling spaces between the adjacent element wires with a highly heat-conductive resin; and
impregnating the coils and the core and filling spaces between the coils and the core with either the highly heat-conductive resin or other highly heat-conductive resin.

9. A method of manufacturing an electrical rotary machine including coils having element wires wound, and a core for holding the coils, the method comprising the steps of:
impregnating the core and covering a surface of the core with a highly heat-conductive resin; and
impregnating the coils and the impregnated core and filling spaces, both between the coils and the impregnated core and between the adjacent element wires, with the highly heat-conductive resin.
